(19) United States
(12) Patent Application Publication
(10) Pub. No.: US 2015/0229249 A1
(43) Pub. Date: Aug. 13, 2015

(54) ELECTRONIC MOTOR-GENERATOR SYSTEM AND METHOD FOR CONTROLLING AN ELECTRIC MOTOR-GENERATOR

(71) Applicant: GM GLOBAL TECHNOLOGY OPERATIONS LLC, Detroit, MI (US)

(72) Inventors: Jihoon Jang, Torrance, CA (US); Yo Chan Son, Rochester Hills, MI (US); Ronghui Li, Torrance, CA (US); Reynaldo Arturo Suazo Zepeda, Beverly Hills, MI (US)

(73) Assignee: GM GLOBAL TECHNOLOGY OPERATIONS LLC, Detroit, MI (US)

(21) Appl. No.: 14/179,590

(22) Filed: Feb. 13, 2014

(51) Int. Cl. H02P 6/08; H02P 9/00

(52) U.S. Cl. CPC H02P 6/08; H02P 9/006

(57) ABSTRACT

A method can be used to control an electric motor-generator in order to avoid demagnetization of the permanent magnets in the electric motor-generator. The method includes the following steps: (a) receiving, via a control module, a torque command input; (b) determining, via the control module, an available torque of the electric motor-generator based, at least in part, on a rotor temperature and a magnitude of an electric current in the stator; (c) determining, via the control module, a torque command based, at least in part, on the available torque and the torque command input; and (d) commanding, via the control module, the electric motor-generator to generate torque in accordance with the torque command in order to avoid demagnetization of the permanent magnets.

### TECHNICAL FIELD

The present disclosure relates to an electronic motor-generator system and method for controlling an electric motor-generator in order to avoid demagnetizing of the permanent magnets of the electric motor-generator.

### BACKGROUND

Permanent magnet electric motor-generators can transform electric power to mechanical torque. Some permanent magnet electric motor-generators may be multiphase interior permanent magnet (IPM) electric motor-generators that include permanent magnets buried within a rotor core and aligned longitudinally with an axis of rotation. Stators include an annular stator core and a plurality of electrical windings. Stator cores include a plurality of radial inwardly projecting tooth elements that are parallel to a longitudinal axis of the electric motor-generator and define an inner circumference of the stator. Contiguous radial inwardly projecting tooth elements form radially-oriented longitudinal slots. Electrical windings are fabricated from strands of suitable conductive material, e.g., copper or aluminum, and are woven or otherwise arranged into coil groups that are inserted into the radially-oriented slots between the tooth elements. Electrical windings are arranged electrically in series in circular fashion around the circumference of the stator core, with each electrical winding associated with a single phase of the electric motor-generator. Each coil group of the electrical windings provides a single pole of a single phase of motor operation. The quantity of radially-oriented slots in the stator core is determined based upon the quantity of phases and poles of the electrical wiring windings for the electric motor-generator. Thus, a three-phase, two-pole motor typically has electrical windings that are configured as six coil groups. Current flow through the electrical windings is used to generate rotating magnetic fields that act on a rotor to induce torque on a shaft of the rotor.

Rotors for permanent magnet electric motor-generators include a rotor core attached to a rotating shaft that defines an axis of rotation, and have a plurality of rotor magnets positioned around the circumference near an outer surface of the rotor core, with each rotor magnet aligned longitudinally with the axis of rotation.

Electric motor-generators include an air gap between tooth elements of a stator and an outer surface of a rotor. An air gap is a design feature that physically separates the rotor and stator part to accommodate manufacturing tolerances and facilitate assembly, and address other known factors. An air gap is preferably minimized, as an increased air gap correlates to reduced magnetic flux and associated reduced output torque of the electric motor-generator.

When electric current flows through the stator windings, a magnetic field is induced along the electrical windings to act upon the rotor magnets of the rotor element. The magnetic field induces torque on the rotating shaft of the rotor. When the magnetic field induces sufficient torque to overcome bearing friction and any induced torque load on the shaft, the rotor rotates the shaft.

Permanent magnet electric motor-generators, including IPM motors, may be used in vehicle propulsion applications. An electric motor-generator may be sized according to expected load profiles such duty cycles of the vehicle and overall efficiency and power loss. Operating temperature of permanent magnet electric motor-generator (e.g., winding temperature) is dependent upon an actual operating load and duty cycle. In an operating regime including prolonged operation at peak output power, an electric motor-generator may overheat. Overheating may demagnetize permanent magnets, thus degrading motor performance and reducing electric motor-generator life. In addition to overheating, unusually high stator currents may demagnetize permanent magnets in the electric motor-generator. It is therefore useful to develop a method and system capable of controlling an electric motor-generator in order to avoid demagnetization of the permanent magnets due to high stator currents and overheating of the permanent magnets.

### SUMMARY

The present disclosure relates to a method of controlling an electric motor-generator in order to avoid demagnetization of the permanent magnets in the electric motor-generator. The electric motor-generator includes a stator and a rotor. The rotor includes permanent magnets and is rotatably coupled to the stator. In an embodiment, the method includes the following steps: (a) receiving, via a control module, a torque command input; (b) determining, via the control module, an available torque of the electric motor-generator based, at least in part, on a rotor temperature and a magnitude of an electric current in the stator; (c) determining, via the control module, a torque command based, at least in part, on the available torque and the torque command input; and (d) commanding, via the control module, the electric motor-generator to generate torque in accordance with the torque command in order to avoid demagnetization of the permanent magnets.

The present disclosure also relates to an electric motor-generator system. In an embodiment, the electric motor-generator system includes an electric motor-generator including a stator and a rotor. The rotor has permanent magnets and is rotatably coupled to the stator. The electric motor-generator system further includes an energy storage device configured to supply electrical energy and an inverter module electrically connected to the energy storage device and the electric motor-generator. The inverter module is configured to change direct current (DC) to alternating current (AC) and includes a control module. The control module is programmed and configured to execute the followings instructions: (a) receive a torque command input; (b) determine an available torque of the electric motor-generator based, at least in part, on a rotor temperature and a magnitude of an electric current in the stator; (c) determine a torque command based, at least in part, on the available torque and the torque command input; and (d) command the electric motor-generator to generate torque in accordance with the torque command in order to avoid demagnetization of the permanent magnets.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic, side view of a vehicle including an electric motor-generator system;

FIG. 2 is a schematic diagram of the electric motor-generator system schematically illustrated in FIG. 1;

FIG. 3 is a flowchart illustrating a method for controlling an electric motor-generator of the electric motor-generator system in order to avoid demagnetization of the permanent magnets in the electric motor-generator;

FIG. 4 is a flowchart illustrating part of the method of FIG. 3 used for determining the operating mode of the electric motor-generator;

FIG. 5 is a flowchart illustrating part of the method of FIG. 3 used for determining a root mean square (RMS) current limit of the electric motor-generator;

FIG. 6 is a flowchart illustrating part of the method of FIG. 3 used for determining at least one derated torque limit;

FIG. 7 is a flowchart illustrating part of the method of FIG. 3 used for determining a voltage scaling factor;

FIG. 8 is a flowchart illustrating part of the method of FIG. 3 used for determining a torque limit adjustment;

FIG. 9 is a schematic block diagram of a RMS current regulator used in the method of FIG. 3;

FIG. 10 is a flowchart illustrating part of the method of FIG. 3 used for determining adjusted torque limits;

FIG. 11 is a flowchart illustrating a part of the method of FIG. 3 used for determining the available torque in the electric motor-generator; and

FIG. 12 is a flowchart illustrating part of the method of FIG. 3 used for determining the torque command for the electric motor-generator.

### DETAILED DESCRIPTION

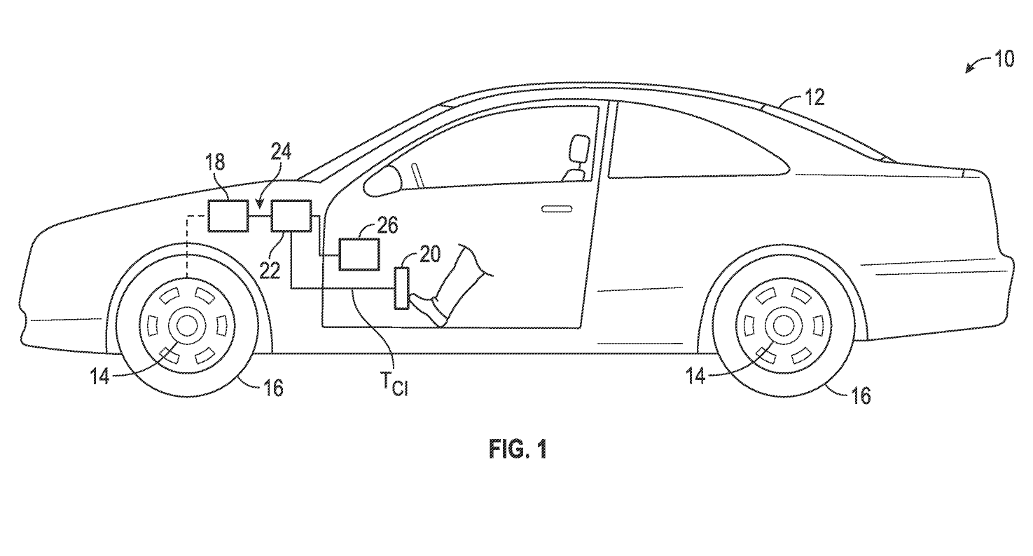

Referring now to the drawings, wherein the like numerals indicate corresponding parts throughout the several views, FIG. 1 schematically illustrates a vehicle 10, such as a car, including a vehicle body 12, a plurality of wheels 14 operatively coupled to the vehicle body 12, and a permanent magnet electric motor-generator 18 for propelling the vehicle 10. Each wheel 14 is coupled to a tire 16. The vehicle 10 further includes an accelerator 20, such as a pedal, operatively coupled to the electric motor-generator 18 via a control system 22 for controlling the electric motor-generator 18. The control system 22 and the electric motor-generator 18 jointly define an electric motor-generator system 24. A user may actuate the accelerator 20 to send a torque command input or torque request to the electric motor-generator 18 via the control system 22. As a non-limiting example, the user may depress the actuator 20 (e.g., pedal) in order to send a torque command input T_{CI} to the electric motor-generator 18 via the control system 22. In response to the torque command input T_{CI}, the electric motor-generator 18 converts electric energy to kinetic energy, thereby generating torque in accordance with the torque command input T_{CI}. The torque generated by the electric motor-generator 18 is then transferred to the wheels 14 in order to propel the vehicle 10.

The electric motor-generator 18 is electrically connected to an energy storage device 26, such as one or more batteries, and can therefore receive electrical energy from the energy storage device 26. The energy storage device 26 may be a direct current (DC) power supply, can store electrical energy, and can supply the electrical energy to the electric motor-generator 18 via the control system 22 and to other components of the vehicle 10, such as power steering and a heating ventilation and air conditioning (HVAC) systems.

It is contemplated that the electric motor-generator 18 may operate in a motoring mode and a regenerating mode. In the motoring mode, the electric motor-generator 18 can propel the vehicle 10 by converting the electrical energy received from the energy storage device 26 into kinetic energy. This kinetic energy is then transmitted (in the form of torque) to the wheels 14 in order to propel the vehicle 10. In the regenerating mode, the electric motor-generator 18 converts kinetic energy (stemming from another power source such as an internal combustion engine) into electrical energy. This electrical energy is then supplied to the energy storage device 26.

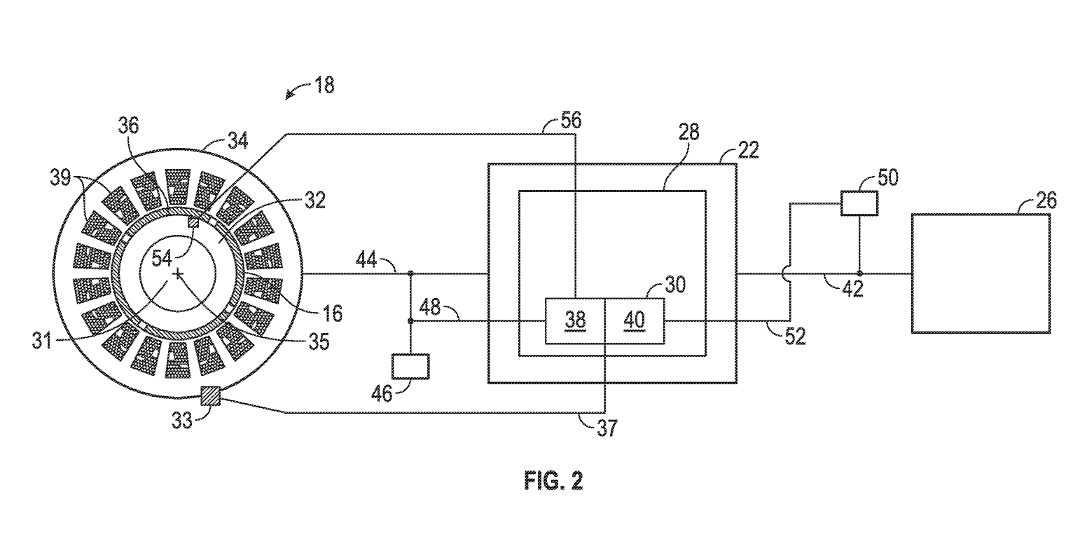

With reference to FIG. 2, the permanent magnet electric motor-generator 18 is electrically connected to the control system 22. The control system 22 includes an inverter module 28 electrically connected to the energy storage device 26, which may be DC power supply. The inverter module 28 is electrically connected to the permanent magnet electric motor-generator 18 and may be an electronic device or circuitry that changes direct current (DC) to alternating current (AC). As a non-limiting example, the inverter module 28 may produce a square wave. It is envisioned that the inverter module 28 may alternatively produce modified sine wave, pulsed sine wave, or sine wave depending on the circuit design. A DC bus line 42 may electrically connect the energy storage device 26 to the inverter module 28.

The permanent magnet electric motor-generator 18 includes a rotor 32 mounted on a shaft 31. A center line of the shaft 31 defines a longitudinal axis that is an axis of rotation 35 of the rotor 32. The rotor 32 includes a plurality of permanent magnets 36 mounted or otherwise attached at or near an external surface thereof. The rotor 32 is inserted into a coaxial hollow cylindrical stator 34. The rotor 32 is rotatably coupled to the stator 34. The stator 34 includes a plurality of stator windings 39 arranged in a multiphase manner. The inverter module 28 is electrically connected to the permanent magnet electric motor-generator 18 using a quantity of electrical leads 44 corresponding to the plurality of stator windings 39. The cross-sectional view of the permanent magnet electric motor-generator 18 is shown orthogonal to the axis of rotation 35 of the rotor 32. A rotational position sensor 33 is suitably mounted to monitor an angular position of the rotor 32 to determine rotational speed thereof. The rotational position sensor 33 can then communicate a rotational position signal 37 to the control system 22. The rotational position signal 37 is indicative of the rotational position of the rotor 32. Alternatively, reference number 33 represents a rotational speed sensor capable of determining the rotational speed of the rotor 32. In such case, the reference number 37 represents a rotational speed signal 37, which is indicative of the rotational speed of the rotor 32. The rotational position sensor 33 may be a halls effect sensor, an encoder, an optical sensor, a magnetoresistive sensor, and/or a combination thereof.

The inverter module 28 includes a plurality of gate drives (not shown) and an associated control module 30. The terms “control module,” “module,” “control,” “controller,” “control unit,” “processor” and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or steps, combinational logic circuit(s), sequential logic circuit(s), input/output circuit(s) and devices, appropriate signal conditioning and buffer circuitry, and other components to provide the described functionality. “Software,” “firmware,” “programs,” “instructions,” “steps,” “code,” “algorithms” and similar terms mean any controller executable instruction sets. In the depicted embodiment, the control module 30 includes at least one processor 38 and at least one memory 40 in electronic communication with the processor 38. The processor 38 can execute one or more software or firmware programs or steps, and the memory 40 can store software or firmware programs or steps.

The gate drives (not shown) of the inverter module 28 correspond to selected portions of the stator windings 39 of the permanent magnet electric motor-generator 18 and are arranged in a suitable manner to control individual phases thereof. As a non-limiting example, the inverter module 28 may include six gate drives arranged in three pairs to control flow of electric power to the permanent magnet electric motor-generator 18 in three phases. The gate drives may include insulated-gate bipolar transistors (IGBTs) or other suitable devices.

The control system 22 additionally includes at least one current sensor 46 configured to determine the electric current magnitude through leads 44, thus generating corresponding current signals 48 that are monitored by the control module 30. The electric current magnitude through the leads 44 may correspond to the magnitude of the electric current in the stator 34. Aside from the current sensors 46, the control system 22 includes a voltage sensor 50 configured to determine the voltage in the DC bus line 42 (i.e., the DC bus voltage V_{dc}) and communicated a corresponding voltage signal 52 to the control module 30. The control system 22 further includes a temperature sensor 54, such as a thermocouple, configured to determine the temperature of the rotor 32 and communicate a rotor temperature signal 56 to the control module 30.

In operation, the control module 30 sequentially activates the gate drives (not shown) of the inverter module 28 to transfer electric current from the energy storage device 26 to one of the phases of the stator windings 39. The electric current induces a magnetic field in the stator windings 39 that acts on the permanent magnets 36 and induces rotation of the rotor 32 on the shaft 31 about the axis of rotation 35. The control module 30 controls timing of activation of the gate drives of the inverter module 28 to control rotational speed and torque output of the permanent magnet electric motor-generator 18.

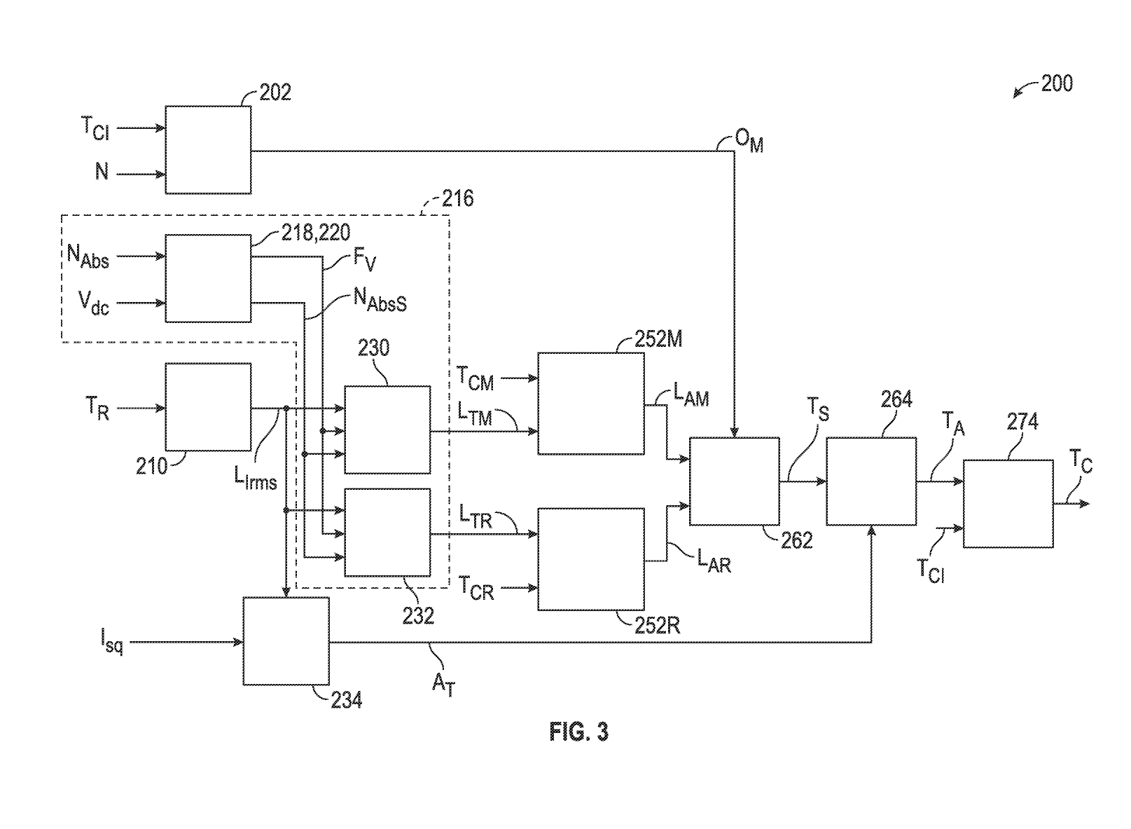

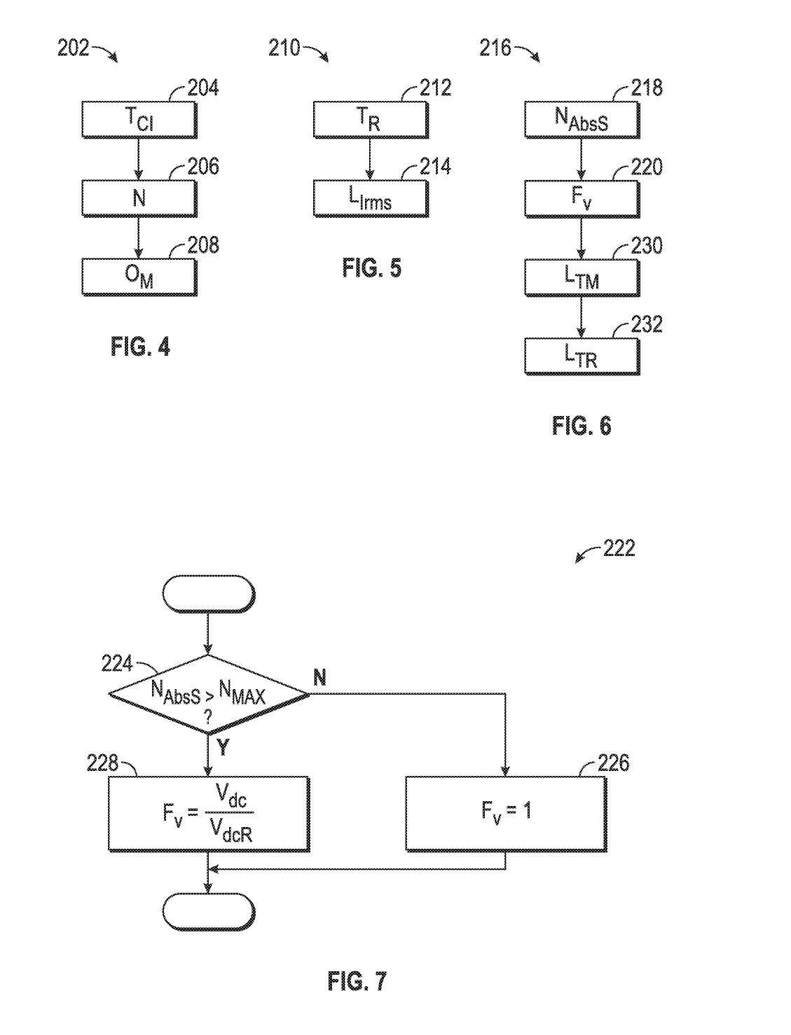

With reference to FIGS. 3 and 4, the control system 22 (FIG. 2) can execute the method 200 in order to minimize the risk of permanent magnet demagnetization. The method 200 includes a plurality of steps. As a non-limiting example, FIG. 4 is a flowchart of a first step 202 of the method 200. The first step 202 is used for determining the operating mode O_{M} of the electric motor-generator 18 and begins with substep 204, in which the control module 30 receives a torque command input T_{CI}. The toque command input T_{CI} may be determined in a previous execution period. Substep 204 therefore entails receiving, via the control module 30, a torque command input T_{CI}. The control module 30 may receive the torque command input T_{CI} upon actuation of the accelerator 20 (FIG. 1). In other words, a user may actuate (e.g., depress) the accelerator 20 in order to send a torque command input T_{CI} to the control module 30. Then, control module 30 executes substep 206. In substep 206, the control module 30 determines the speed of the electric motor-generator 18 (i.e., motor speed N). For example, in substep 206, the control module 30 can determine the motor speed N (i.e., the speed of the electric motor-generator 18) based at least in part on the rotational position signal 37 (or rotational speed signal) generated by the rotational position sensor 33 (or rotational speed sensor). Next, in substep 208, the control module 30 determines the operation mode O_{M} of the electric motor-generator 18 (FIG. 2). As discussed above, the electric motor-generator 18 may operate in motoring mode and a regenerating mode. In the motoring mode, the electric motor-generator 18 can propel the vehicle 10 by converting the electrical energy received from the energy storage device 26 into kinetic energy. Thus, in substep 208, the control module 30 determines if the electric motor-generator 18 is operating in motoring or regenerating mode.

With reference to FIGS. 3 and 5, the method 200 further includes a second step 210 for determining a root mean square (RMS) current limit L_{Irms} for the electric motor-generator 18 based at least in part on the rotor temperature T_{R} (the temperature of the rotor 32) in order to derate the current magnitude. The second step 210 begins at substep 212, in which the control module 30 determines the rotor temperature T_{R} (the temperature of the rotor 32). In particular, substep 212 entails determining the rotor temperature T_{R} based at least in part on the rotor temperature signal 56 generated by the temperature sensor 54 (FIG. 2). Alternatively, a temperature estimator can be used to in order to determine the rotor temperature. Next, at substep 214, the control module 30 can determine the RMS current limit L_{Irms} based on the rotor temperature T_{R} using a one-dimensional lookup table. This look-up table may be stored in the memory 40 and can be generated by testing the electric motor-generator 18. Substep 214 therefore entails determining the RMS current limit L_{Irms} based at least in part on the rotor temperature T_{R}.

With reference to FIGS. 3 and 6, the method 200 further includes a third step 216 for determining at least one derated torque limit based at least in part on the RMS current limit L_{Irms} previously determined in the second step 210. In the depicted embodiment, the third step 216 entails determining a first or motoring derated torque limit L_{TM} and a second or regenerating derated torque limit L_{TR}. The third step 216 begins with substep 218. Substep 218 entails determining, using the control module 30, a scaled absolute motor speed N_{AbsS} based at least in part on the absolute motor speed N_{Abs}. Specifically, the control module 30 is programmed to determine the scaled absolute motor speed N_{AbsS} based on the absolute motor speed N_{Abs}, the DC bus voltage V_{dc}, and a reference DC bus voltage V_{dcR}. The control module 30 can determine the absolute motor speed N_{Abs} based at least in part on the rotational position signal 37 (or rotational speed signal) generated by the rotational position sensor 33 (or rotational speed sensor). Further, the control module 30 can determine the DC bus voltage V_{dc}, based on the voltage signal 52 generated by the voltage sensor 50. Moreover, the control module 30 can retrieve the reference DC bus voltage V_{dcR} from a two dimensional lookup stable stored in the memory 40 (FIG. 2). As a non-limiting example, the control module 30 is programmed to determine the scaled absolute motor speed N_{AbsS} based on the absolute motor speed N_{Abs} using Equation (1) below:

$${N}_{AbsS} = {N}_{Abs} \frac{{V}_{dcR}}{{V}_{dc}} \qquad ( 1 )$$

wherein:
N_{AbsS} is the scaled absolute motor speed;
N_{Abs} is the absolute motor speed;
V_{dc} is the DC bus voltage; and
V_{dcR} is the reference DC bus voltage.

After performing substep 218, the control module 30 executes substep 220 in order to determine a voltage scaling factor Fᵥ based at least in part on the absolute motor speed N_{Abs}, the DC bus voltage V_{dc}, the reference DC bus voltage V_{dcR}, and a maximum motor speed N_{MAX}. The control module 30 can obtain the maximum motor speed N_{MAX} from a lookup table stored in the memory 40.

FIG. 7 is a flowchart illustrating a method 222 for determining the voltage voltage scaling factor Fᵥ. The method 222 begins at substep 224, which the control module 30 compares the scaled absolute motor speed N_{AbsS} to the maximum motor speed N_{MAX}. If the scaled absolute motor speed N_{AbsS} is not greater than the maximum motor speed N_{MAX}, then the method 222 continues to substep 226, in which the control module 30 equates the value of voltage scaling factor Fᵥ to one. If the scaled absolute motor speed N_{AbsS} is greater than the maximum motor speed N_{MAX}, then the method 222 continues to substep 228, in which the control module 30 determines the voltage scaling factor Fᵥ based at least in part on the DC bus voltage V_{dc} and the reference DC bus voltage V_{dcR}. As a non-limiting example, in substep 228, the control module 30 can determine the voltage scaling factor Fᵥ using Equation (2) below:

Fᵥ=V_{dc}/V_{dcR} (2)

wherein:
Fᵥ is the voltage scaling factor;
V_{dc} is the DC bus voltage; and
V_{dcR} is the reference DC bus voltage.

With reference again to FIGS. 3 and 6, after determining the voltage scaling factor Fᵥ and the scaled absolute motor speed N_{AbsS}, the control module 30 executes substep 230 in order to determine the first or motoring derated torque limit L_{TM} based at least in part on the RMS current Limit L_{Irms}, the voltage scaling factor Fᵥ, and the scaled absolute motor speed N_{AbsS}. Specifically, in substep 230, the control module 30 can determine the first or motoring derated torque limit L_{TM} using a two-dimensional lookup table indexed by RMS current Limit L_{Irms} and the scaled absolute motor speed N_{AbsS} followed by a scaling using the voltage scaling factor Fᵥ This lookup table may be generated by testing the electric motor-generator 18. Then, the control module 30 executes substep 232. In sub step 232, the control module 30 determines the regenerating derated torque limit L_{TR} based at least in part on RMS current Limit L_{Irms}, the voltage scaling factor Fᵥ, and the scaled absolute motor speed N_{AbsS}. Specifically, in substep 232, the control module 30 can determine the regenerating derated torque limit L_{TR} using a two-dimensional lookup table indexed by RMS current Limit L_{Irms} and the scaled absolute motor speed N_{AbsS} followed by scaling using the voltage scaling factor Fᵥ This lookup table may be generated by testing the electric motor-generator 18.

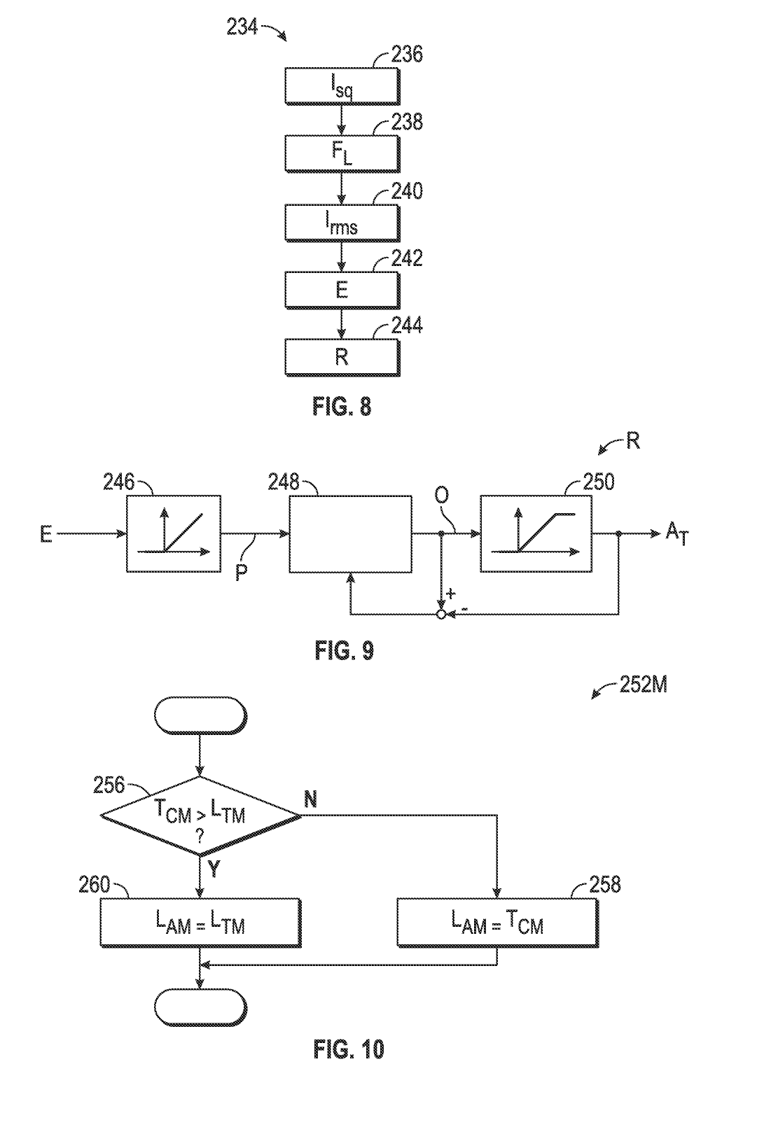

With reference to FIGS. 3 and 8, the method 200 further includes a fourth step 234 used for determining a torque limit adjustment A_{T} based at least in part on the magnitude of the electric current in the stator 34. The torque limit adjustment A_{T} refers to the amount of torque that must be additionally reduced (in relation to the motoring derated torque limit L_{TM} and the regenerating derated torque limit L_{TR}) in order to maintain the magnitude of the RMS current Iᵣₘₛ below the RMS current limit L_{Irms} and is used to compensate for errors in the lookup tables described above. The fourth step 234 begins at substep 236, in which the control module 30 receives a squared current signal I_{sq} (or another current signal having a different waveform). In this disclosure, the “squared current signal” means the squared value of the magnitude of the current. The squared current signal I_{sq} may be indicative of the electric current in the stator 34. In substep 236, the control module 30 may receive the squared current signal I_{sq} from the current sensor 46 (FIG. 2). As discussed above, the current sensor 46 can generate a current signal 48 (FIG. 2), which may correspond to the square current signal I_{sq}. Next, the squared current signal I_{sq} is then processed using a low-pass filter F_{L} in substep 238. The low-pass filter F_{L} reduces the amplitude (i.e., attenuates) square current signals I_{sq} with frequencies higher than a cutoff frequency in order to generate a filtered squared current signal I_{fsq}. Substep 238 therefore entails filtering the square current signal I_{fsq}. Then, control module 30 executes substep 240. In substep 240, the control module 30 determines (i.e., calculates) the RMS current Iᵣₘₛ based on the filtered squared current signal I_{fsq}. Substep 240 therefore entails determining the RMS current Iᵣₘₛ based at least in part on the filtered squared current signal I_{fsq}. As a non-limiting example, the RMS current Iᵣₘₛ may be calculated by adding the values of the amplitudes of the filtered squared current signal I_{fsq} to obtain the sum of such amplitudes, multiplying the sum of such amplitudes by 0.5 to obtain the arithmetic mean of such sum, and calculating the square root of the calculated arithmetic mean of the amplitudes. After determining the RMS current Iᵣₘₛ, the control module 30 executes substep 242. In substep 242, the control module 30 determines an RMS current error E by subtracting the RMS current limit L_{Irms} from the RMS current Iᵣₘₛ. Next, the control module 30 executes substep 244, in which an RMS current regulator R tries to reduce the RMS current Iᵣₘₛ toward the RMS current limit L_{Irms}. In substep 244, the RMS current regulator R compensates for the errors in the lookup tables described above or motor parameters changes and generates the torque limit adjustment A_{T}.

FIG. 9 is a non-limiting example of a RMS current regulator R used for determining the torque limit adjustment A_{T}. In the depicted embodiment, the RMS current regulator R includes a first or input clamper 246 (i.e., a positive clamper) capable of processing the RMS current error E so that the input signal (i.e., RMS current error E) has a value greater than zero. As used herein, the term “clamper” refers to a software or circuit (e.g., clamping circuit or other hardware) capable of processing the RMS current error E or other signal. In other words, the first clamper 246 receives the RMS current error E and generates a purely positive signal P. The RMS current regulator R further includes a proportional-integral (PI) controller 248 (or any other suitable closed loop feedback mechanism) that receives and processes the purely positively signal P. The term “PI controller” refers to a closed loop feedback mechanism (e.g., software and/or hardware) that includes a proportional term and an integral term. The proportional term produces an output value that is proportional to the current error value (e.g., RMS current error E), and the integral term produces the sum of the instantaneous error over time. The PI controller 248 may include an anti-windup scheme. The term “anti-wide scheme” refers to software or circuits capable of preventing integral windup in a PI controller. The term “integral windup” refers to the situation in a PI controller where a large change in set point occurs (e.g., positive change) and the integral terms accumulates a significant error during the rise (windup), thus overshooting and continuing to increase as this accumulated error is unwound (offset by errors in the other direction). The RMS current regulator R additionally includes a second or output clamper 250 configured to process the output signal 0 of the PI controller 248 so that the output signal 0 is greater than zero and less than a maximum value (which is stored in the memory 40) and thereby generates the torque limit adjustment A_{T}.

With reference to FIGS. 3 and 10, the method 200 further includes a fifth and sixth steps 252M, 252R for determining a first or motoring, adjusted torque limit L_{AM} and second or regenerating, adjusted torque limit L_{AR}, respectively. Specifically, the fifth step 252M can be used to determine the first adjusted torque limit L_{AM} based at least in part on the first derated torque limit L_{TM} and the original, motoring torque capacity T_{CM} of the electric motor-generator 18. The original, motoring torque capacity T_{CM} of the electric motor-generator 18 can be stored in the memory 40 (FIG. 2), and the first derated torque limit L_{TM} is determined as discussed above with respect to substep 230. The sixth step 252R can be used to determine the second adjusted torque limit L_{AR} based at least in part on the second derated torque limit L_{TR} and the original, regenerating torque capacity T_{CR} of the electric motor-generator 18. The original, regenerating torque capacity T_{CR} of the electric motor-generator 18 can be stored in the memory 40 (FIG. 2), and the second derated torque limit L_{TR} is determined as discussed above with respect to substep 232. Although the fifth and sixth steps 252M, 252R have different inputs, these steps use the same process as shown in FIG. 10. In the interest of brevity, only the fifth step 252M is discussed in detail. However, the process of the sixth step 252R is the same as process of the fifth step 252M, though with different inputs.

With specific reference to FIG. 10, the fifth step 252M begins with substep 256, in which the control module 30 compares the original, motoring torque capacity T_{CM} to the first derated torque limit L_{TM}. If the original, motoring torque capacity T_{CM} is not greater than the first derated torque limit L_{TM}, then the control module 30 equates the first adjusted torque limit L_{AM} to the original, motoring torque capacity T_{CM} at substep 258. If the original, motoring torque capacity T_{CM} is greater than the first derated torque limit L_{TM}, then the control module 30 equates the first adjusted torque limit L_{AM} to the first derated torque limit L_{TM} at substep 260. In case of the sixth step 252R, substep 256 entails comparing the original, regenerating torque capacity T_{CM} to the second derated torque limit L_{TM}; substep 258 entails equating the second adjusted torque limit L_{AR} to the original, regenerating torque capacity T_{CM} if the original, regenerating torque capacity T_{CM} is not greater than the second derated torque limit L_{TM}; and substep 260 entails equating the second adjusted torque limit L_{AR} to the second derated torque limit L_{TM} if the original, regenerating torque capacity T_{CM} is greater than the second derated torque limit L_{TM}.

With reference again to FIG. 3, the method 200 additionally includes a seventh step 262, which entails selecting between the first adjusted torque limit L_{AM} and second adjusted torque limit L_{AR} based on the operating mode O_{M} of the electric motor-generator 18. If the electric motor-generator 18 is operating in the motoring mode, then the control module 30 selects the first adjusted torque limit L_{AM} (i.e., selected torque limit Tₛ). Conversely, if the electric motor-generator 18 is operating in the regenerating mode, then the control module 30 selects the second adjusted torque limit L_{AR} (i.e., selected torque limit Tₛ).

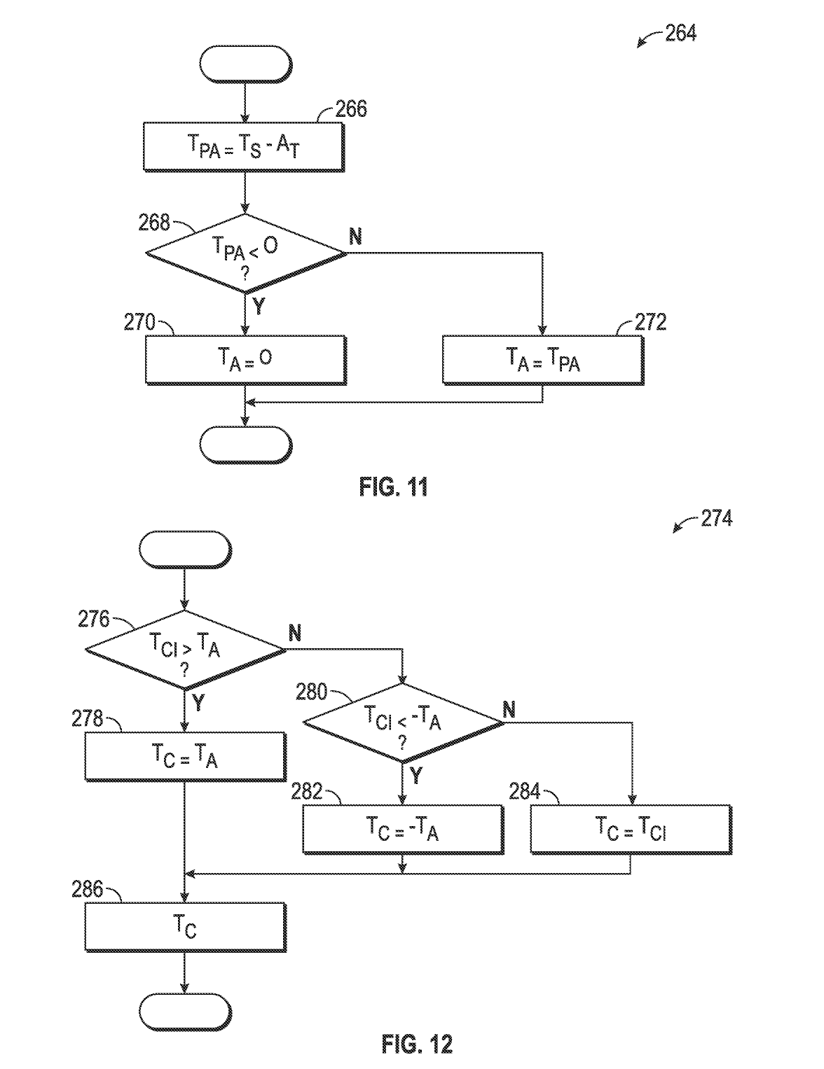

With reference now to FIGS. 3 and 11, after determining the selected torque limit Tₛ, the method 200 proceeds to the eighth step 264, in which the control module 30 determines the available torque T_{A} in the electric motor-generator 18 based on the selected torque limit Tₛ and torque limit adjustment A_{T}. Because the selected torque limit Tₛ and torque limit adjustment A_{T} depend from the rotor temperature T_{R} (the temperature of the rotor 32) and the magnitude of the electric current in the stator 34, the eighth step 264 entails determining, via the control module 30, determining the available torque T_{A} based, at least in part, on the magnitude of the electric current in the stator 34 and the rotor temperature T_{R}. As shown in FIG. 11, the eighth step 264 includes several substeps and begins with substep 266. Substep 266 entails determining a preliminary available torque T_{PA} based at least in part on the selected torque limit Tₛ and torque limit adjustment A_{T}. To do so, in substep 266, the control module 30 subtracts the torque limit adjustment A_{T} from the selected torque limit Tₛ in order to determine the preliminary available torque T_{PA}. Then, the control modules 30 executes substep 268 to determine if the preliminary available torque T_{PA} is less than zero. Substep 268 therefore entails determining if the preliminary available torque T_{PA} is less than zero. If the preliminary available torque T_{PA} is less than or equal to zero, the control module 30 executes substep 270. In substep 270, the control module 30 equates the available torque T_{A} of the electric motor-generator 18 to zero. Substep 270 therefore entails equating, via the control module 30, the available torque T_{A} of the electric motor-generator 18 to zero if the preliminary available torque T_{PA} is less than or equal to zero. Conversely, if the preliminary available torque T_{PA} is greater than zero, then the control module 30 executes substep 272. In substep 272, the control module 30 equates the available torque T_{A} to the preliminary available torque T_{PA}. Substep 272 therefore entails equating, via the control module 30, the available torque T_{A} to the preliminary available torque T_{PA} if the preliminary available torque T_{PA} is greater than zero.

With reference to FIGS. 3 and 12, the method 200 executes a ninth step 274 after determining the available torque T_{A} of the electric motor-generator 18. The ninth step 274 is used to determine the torque command T_{C} for the electric motor-generator 18 based on the available torque T_{A} and the torque command input T_{CI}. The ninth step 274 therefore entails determining, via the control module 30, the torque command T_{C} based at least in part on the available torque T_{A} and the torque command input T_{CI}. In addition, the ninth step 274 includes commanding, via the control module 30, the electric motor-generator 18 to generate torque in accordance with the determined torque command T_{C}. As shown in FIG. 12, the ninth step 274 begins with substep 276. In substep 276, the control module 30 compares the torque command input T_{CI} to the available torque T_{A} in order to determine if the torque command input T_{CI} is greater than the available torque T_{A} of the electric motor-generator 18. Substep 276 therefore entails determining, via the control module 30, if the torque command input T_{CI} is greater than the available torque T_{A} of the electric motor-generator 18. If the torque command input To is greater than the available torque T_{A} of the electric motor-generator 18, the control module 30 executes substep 278. In substep 278, the control module 30 equates the torque command T_{C} to the available torque T_{A}. Conversely, if the torque command input T_{CI} is not greater than the available torque T_{A} of the electric motor-generator 18, the control module 30 executes substep 280. In substep 280, the control module 30 compares the torque command input T_{CI} to the negative value of the available torque T_{A} in order to determine if the torque command input T_{CI} is less than the negative value of the available torque −T_{A}. If the torque command input T_{CI} is less than the negative value of the available torque −T_{A}, the control module 30 executes substep 282. In substep 282, the control module 30 equates the torque command T_{C} to the negative value of the available torque −T_{A}. Conversely, if the torque command input T_{CI} is not less than the negative value of the available torque −T_{A}, the control module 30 executes substep 284. In substep 284, the control module 30 equates the torque command T_{C} to the torque command input T_{CI}. After determining the torque command T_{C}, the control module executes substep 286. In substep 286, the control module 30 commands the electric motor-generator to generate torque in accordance with the torque command T_{C}.

While the best modes for carrying out the invention have been described in detail, those familiar with the art to which this invention relates will recognize various alternative designs and embodiments for practicing the invention within the scope of the appended claims. The terms “first,” “second,” “fourth,” “fifth,” “sixth” etc. do not necessarily denote a chronological sequence. Rather, these numerical terms are used to distinguish components, modules, or steps.

1. A method of controlling an electric motor-generator, the electric motor-generator including a stator and a rotor having permanent magnets and being rotatably coupled to the stator, the method comprising:
receiving, via a control module, a torque command input;
determining, via the control module, an available torque of the electric motor-generator based, at least in part, on a rotor temperature and a magnitude of an electric current in the stator;
determining, via the control module, a torque command based, at least in part, on the available torque and the torque command input; and
commanding, via the control module, the electric motor-generator to generate torque in accordance with the torque command in order to avoid demagnetization of the permanent magnets.

2. The method of claim 1, wherein determining the available torque includes:
determining an operation mode of the electric motor-generator, the electric motor-generator being capable of operating in a motoring mode or a regenerating mode.

3. The method of claim 2, wherein determining the available torque includes:
determining a root mean square (RMS) current limit for the electric motor-generator based at least in part on the rotor temperature.

4. The method of claim of claim 3, wherein the determining the available torque includes:
determining first and second derated torque limits based at least in part on the RMS current limit, wherein the first derated torque limit is related to the motoring mode and the second derated torque limit is related to the regenerating mode.

5. The method of claim 4, wherein determining first and second derated torque limits includes:
determining a scaled absolute motor speed based at least in part on an absolute motor speed of the electric motor-generator.

6. The method of claim 5, wherein the wherein the determining first and second derated torque limits includes:
determining a voltage scaling factor based at least in part on the scaled absolute motor speed, a DC bus voltage, a reference DC bus voltage, and a maximum motor speed, wherein a DV bus voltage is a voltage across a DC bus line between an energy storage device and an inverter module.

7. The method of claim 6, wherein the first and second derated torque limits are based at least in part on the voltage scaling factor and the scaled absolute motor speed.

8. The method of claim 7, wherein determining the available torque includes:
determining a torque limit adjustment based at least in part on the magnitude of the electric current in the stator.

9. The method of claim 8, wherein determining the torque limit adjustment includes:
receiving a squared current signal indicative of the electric current in the stator.

10. The method of claim 9, wherein determining the torque limit adjustment includes:
attenuating the squared current signal with frequencies higher than a cutoff frequency in order to generate a filtered squared current signal.

11. The method of claim 10, wherein determining the torque limit adjustment includes:
determining an RMS current based at least in part on the filtered squared current signal.

12. The method of claim 11, wherein determining the torque adjustment value includes:
determining an RMS current error by subtracting the RMS current limit from the RMS current.

13. The method of claim 12, wherein determining the torque adjustment value includes:
reducing the RMS current toward the RMS current limit using a RMS current regulator in order to determine the torque adjustment value, wherein the RMS current regulator includes a proportional-integral (PI) controller.

14. The method of claim 13, wherein the PI controller includes an anti-windup scheme.

15. The method of claim 14, wherein the determining the available torque includes:
determining a first adjusted torque limit based at least in part on the first derated torque limit and an original, motoring torque capacity of the electric motor-generator; and
determining a second adjusted torque limit based at least in part on the second derated torque limit and an original, regenerating torque capacity of the electric motor-generator.

16. The method of claim 15, wherein determining the available torque includes:
selecting between the first adjusted torque limit and the second adjusted torque limit based on the operating mode of the electric motor-generator in order to determine a selected torque limit, wherein the available torque is based on the selected torque limit and the torque limit adjustment.

17. An electric motor-generator system, comprising:
an electric motor-generator including a stator and a rotor, the rotor having permanent magnets and being rotatably coupled to the stator;
an energy storage device configured to supply electrical energy;
an inverter module electrically connected to the energy storage device and the electric motor-generator, the inverter module being configured to change direct current (DC) to alternating current (AC), the inverter module including a control module, wherein the control module is programmed to:
receive a torque command input;
determine an available torque of the electric motor-generator based, at least in part, on a rotor temperature and a magnitude of an electric current in the stator;
determine a torque command based, at least in part, on the available torque and the torque command input; and
command the electric motor-generator to generate torque in accordance with the torque command in order to avoid demagnetization of the permanent magnets.

18. The electric motor-generator system of claim 17, wherein the control module is configured to:
determining a root mean square (RMS) current limit for the electric motor-generator based at least in part on the rotor temperature.

19. The electric motor-generator system of claim 18, wherein control module is configured to:
determine an operation mode of the electric motor-generator, the electric motor-generator being capable of operating in a motoring mode or a regenerating mode; and
determine first and second derated torque limits based at least in part on the RMS current limit, wherein the first derated torque limit is related to the motoring mode and the second derated torque limit is related to the regenerating mode.

20. The electric motor-generator system of claim 18, wherein control module is configured to:
determine a scaled absolute motor speed based at least in part on an absolute motor speed of the electric motor-generator; and
determine a voltage scaling factor based at least in part on the scaled absolute motor speed, a DC bus voltage, a reference DC bus voltage, and a maximum motor speed, wherein a DV bus voltage is a voltage across a DC bus line between an energy storage device and the inverter module.
